(19) United States
(12) Patent Application Publication
(10) Pub. No.: US 2026/0249823 A1
(43) Pub. Date: Aug. 27, 2026

(54) Braking System, Vehicle Combination and Method of Operating the Same

(71) Applicant: KNORR-BREMSE Systeme fuer Nutzfahrzeuge GmbH, Muenchen (DE)

(72) Inventors: Csongor DOEME, Muenchen (DE); Tamas KOVACS, Halasztelek (HU)

(21) Appl. No.: 18/875,784

(22) PCT Filed: Jul. 31, 2023
(86) PCT No.: PCT/EP2023/071197

§ 371 Date: Dec. 17, 2024

(30) Foreign Application Priority Data
Aug. 22, 2022 (EP) 22191386.6

(51) Int. Cl. B60T 13/26; B60T 13/68

(52) U.S. Cl. CPC B60T 13/263; B60T 13/683; B60T 2270/402

(57) ABSTRACT

A braking system for a vehicle combination, in particular for an electronic park brake control system or a global scalable air treatment system of a trailer-vehicle combination, includes at least one truck park brake chamber, at least one truck park brake supply port, at least one secondary supply port, at least one secondary supply valve and at least one control valve, preferably a select high valve. The at least one secondary supply valve has a fluid connection to the at least one truck park brake chamber via the control valve such that the at least one truck park brake chamber can be provided with pressure fluid via the truck park brake supply port and/or the secondary supply port. Moreover, a vehicle combination and a method for operating such a braking system and/or vehicle combination is disclosed.

### BACKGROUND AND SUMMARY

The present invention refers to a braking system, in particular for a trailer-vehicle combination, a vehicle combination, in particular a truck-trailer combination, and a method for operating the same.

The today well known and widely applicated park brake chambers are kept in disengaged position via a dedicated pressurized air circuit through the air supply system. If this pressurization is not possible due to a mechanical failure somewhere in the pressurized air circuit, the park brake is being applied, causing brake force on the wheels which are equipped with park brake chambers.

Furthermore, the trailer pressure control line can also be supplied from the same pressurized air circuit. The behavior is the same as in the previously mentioned situation because the trailer brake control is working in such a way that in case the trailer control line is pressurized, there is no brake force, and the brake force is proportional to a (potentially occurring) decrease of pressure in the trailer control line.

In conventional systems, a so called redundant backup piping is provided via pneumatic elements by which the mentioned park brake chambers and trailer control line can be pressurized from another pressurized air circuit to avoid park brake/trailer brake application in case of a loss of pressure.

Considering today's electronic parking brake systems (EPB), if there is a pneumatic line defect between the EPB and the parking brake chambers, the park brake cannot be released, or if this defect occurs during driving, the parking brake cannot be kept released.

In particular, if pressurized air is lost from the park brake, the trailer control line brake force is applied on the wheels. The more the pressure is decreasing, the higher the brake force increases, even up to a complete blockage of the wheel(s).

Once a wheel is blocked, no lateral tire force can be realized on the ground resulting in a complete loss of controllability of the vehicle, leading to potential life threatening situations, besides the possibility of a (costly) damage of property. To determine the point when the wheel blocking becomes critical is nearly impossible, due to several unknown or fast changing variable(s) such as e.g. the vehicle being loaded or empty, the road conditions (dry asphalt, slippery wet/icy asphalt), driver routine, etc.

On the other hand, if the park brake is engaged and, due to the damaged pressurized air circuit, it cannot be disengaged, the vehicle is simply fixed in a standstill. Such braking/standstill situation can lead to dangerous situations like in heavy traffic or on a railway crossing.

According to the state of the art, a second pressure supply for the park brake chambers, supplied from a different circuit than the park brake, is provided in order to minimize/avoid such critical situations. In this context, one way of implementation according to the state of the art is to connect the mentioned different pressure supply circuits to the parking brake chambers with a switchable solenoid which is controlled by an electronic control unit (ECU).

If this ECU detects the (pre-defined) activation conditions—e.g. a pressure breakdown during driving or an attempt to release the parking brake lasting too long without such release occuring—the ECU activates the solenoid and air is supplied to the park brake chambers via the different/secondary pressure circuit. This function is known as “Pipe Fracture Protection” (PFP).

However, if any of the above-mentioned situations happens, with the layout of the park brake system according to the state of the art, the trailer control line will not be supplied properly, but there could be significant brake force on the trailer. Today's short-term solution for such a situation is to disconnect the (usually yellow) coupling head as well as to release the trailer brakes manually.

Besides that, providing a redundant backup piping, in accordance with the state of the art, increases the build cost of a truck, whereby also the specific reaction time depends on several circumstances. Thereby, the behaviour of a purely pneumatic backup system can also depend on environmental conditions.

It is an object of the present invention to provide a braking system, in particular for a trailer-vehicle combination, which is capable of providing a backup functionality, e.g. in case of a leakage, a brake pipe burst/break or the like, but also reduces costs and allows for improved behaviour under different (environmental) circumstances, in particular by utilizing a second source of pressure fluid being connectable on a temporarily basis and as needed. Moreover, it is an object of the invention to provide a vehicle combination as well as a method for operating the braking system and/or the vehicle combination.

This object is solved by a braking system as well as a vehicle combination and a method for operating of such braking system and/or trailer-vehicle combination according to the independent claim(s). Moreover, preferred embodiments are provided in the dependent claims respectively.

According to the present invention a braking system for a trailer-vehicle combination, in particular for an electronic park brake control (EPBC) system or a global scalable air treatment (GSAT) system of a trailer-vehicle combination, is provided with at least one truck park brake chamber, at least one truck park brake supply port, at least one secondary supply port, at least one secondary supply valve and at least one control valve, preferably a select high valve. The control valve comprises a fluid connection to the at least one truck park brake chamber, the at least one secondary supply valve and the truck park brake supply port, wherein the at least one secondary supply valve comprises a fluid connection to the secondary supply port and to the control valve. The at least one secondary supply valve comprises a fluid connection to the at least one truck park brake chamber via the control valve such that the at least one truck park brake chamber can be provided with pressure fluid via the truck park brake supply port and/or the secondary supply port, preferably to allow for pressure fluid to be provided from a primary pressure fluid source via the truck park brake supply port and/or from a secondary pressure fluid source via the secondary supply port to the at least one truck park brake chamber.

The invention is based on the idea of combining two functions of a braking system, like e.g. an EPBC system.

Firstly, in case the brake system detects that the park brake cannot be released, it will actuate the secondary supply valve to supply the truck parking brake chambers with pressure fluid via the secondary supply port and in parallel can (automatically) execute the trailer control line inflation for releasing the trailer service brake, without an attempt to release the truck/tractor's parking brake. By these measures the vehicle combination can be mobilized.

Secondly, if the EPBC system detects the pressure breakdown of the park brake chambers during driving, it can actuate the secondary supply valve to supply the park brake chambers as well as it can, in parallel, automatically activate the trailer control line inflation, thereby keeping the vehicle combination mobilized.

Moreover, by the present invention the so-called ECE 13 regulation can be met, which defines that the whole vehicle combination must be kept standstill just by the towing vehicle's/tractor's/truck's parking brake when a vehicle combination (e.g. tractor-trailer) is parked. To check the compliance with respect to this ECE 13 regulation, the vehicle combination has to have a function where only the trailer service brakes are released, but the tractor's/towing vehicle's parking brake is kept parked/in braking mode. Such situation is realized by inflation of the trailer control line.

The braking system according to the present invention can be applied for/with and/or in the context of, in particular as a part of, an EPBC or a GSAT.

By the at least one secondary supply valve comprising a fluid connection to the secondary supply port and to the control valve it is possible to inflate the truck's/tractor's parking brake (chamber) with pressure fluid either via the truck/tractor park brake supply port or, in particular as a backup option in case of e.g. a pipe burst/breakage, via the secondary supply port.

According to the present invention, the control valve can be an actively and/or a passively controlled valve. Preferably, the control valve can be a (passive) select high valve.

In particular, the control valve can allow for pressure fluid (or in other words also pressure medium) being fed to the truck park brake chamber from the truck park brake supply port or the secondary supply port.

Alternatively, the control valve can allow for proportional feeding according to the fluid pressure being applied at the truck park brake supply port and the secondary supply port respectively.

Moreover, the braking system is preferably configured to be used with air or any other suitable gas as an operational fluid, in particular compressed air. Hence, the braking system can preferably be provided as a pneumatic braking system.

According to one preferred embodiment, the truck park brake supply port and the secondary supply port are capable of providing pressure fluid to the park brake chamber from different, in particular redundant, sources of pressure fluid, preferably from a primary pressure fluid source and a secondary pressure fluid source.

In particular, by the secondary supply port a secondary source of pressure fluid, independent from the truck park brake supply port, can be utilized, which is provided by the usual infrastructure, e.g. of a GSAT or an EPBC.

Hence, no additional pressure fluid source or any extensive piping has to be provided.

Rather, by the secondary supply valve, a simple and cost-efficient backup supply via the secondary supply port can be provided.

In another embodiment of the invention, the braking system further comprises a trailer control line port, for providing pressure fluid to a trailer service brake, and at least one truck-trailer valve, preferably at least one truck-trailer solenoid valve, whereby a fluid connection between a primary pressure fluid source, the truck park brake supply port and/or the trailer control line port is providable via the at least one truck-trailer valve such that at least a (comparable) fluid pressure, preferably the same fluid pressure, can be applied/is applicable at the trailer control line port or at the truck park brake supply port or at both of them simultaneously.

With the trailer control line port, a trailer service brake can be controlled, i.e. released, by applying fluid pressure accordingly.

In particular, the truck-trailer can be utilized to allow for a fluid pressure as provided at the truck park brake supply port to be also or instead available at the trailer control line port.

Moreover, the at least one truck-trailer valve can connect the trailer control line port to a pressure fluid source.

Namely, by the at least one truck-trailer valve, a fluid connection to the primary pressure fluid source of the braking system can be connected to either the truck park brake supply port, the trailer control line port, to both of them or to none of them.

In this context, the truck-trailer valve can be implemented in the form of a single (solenoid) valve or in the form of multiple (solenoid) valves in order to allow for appropriate switching of fluid connections.

Thereby, the trailer's service brake can be released in an efficient manner.

According to one embodiment, the at least one secondary supply valve is provided as a solenoid valve, in particular as a spring-loaded solenoid valve, wherein the at least one secondary supply valve in its deactivated/unswitched/pre-set/spring-loaded state preferably interrupts fluid connection between the secondary supply port and the control valve.

Hence, the usual operation of the braking system allows for a fluid pressure being applied from the truck park brake supply port via the control valve to the truck park brake (chamber(s)).

In case of e.g. a brake pipe burst/breakage or a leakage and a corresponding loss/decrease of fluid pressure along such usual supply line, the secondary supply valve can provide for a fluid connection between the secondary supply port and the control valve such that truck park brake (chamber(s)) can be supplied with sufficient pressure fluid to allow for an operation of the truck's parking brake.

Preferably, the secondary supply valve is a solenoid valve in order to allow a control of the secondary supply valve by a control unit of the braking system and/or the vehicle combination.

In another preferred embodiment, the braking system comprises a sensor unit for detection of a fluid pressure in the fluid connection between the truck park brake supply port and the control valve.

Such a sensor unit can be provided as a specific pressure sensor for measuring the fluid pressure.

Alternatively, various different methods can be applied in order to directly or indirectly determine a fluid pressure and/or a fluid pressure loss between the truck park brake supply port and the high select valve of the braking system.

Pursuant to a further embodiment of the invention, the secondary supply valve is provided as an external valve, in particular to be controlled via an analog control connection, or provided as an integral part of the braking system, in particular as an integral part of an electronic park brake control system or of a global scalable air treatment system.

In particular, the implementation of the secondary supply valve can be provided in various manners, e.g. it can be integrated into the truck system itself, with e.g. a EPBC system only actuating the secondary supply valve via analogue electrical connection.

Alternatively, the braking system, in particular the secondary supply valve, can also be directly implemented as an integral part of an EPBC or a GSAT.

In another preferred embodiment, the secondary supply port is a trailer tank supply port and/or comprises a fluid connection to a trailer tank as a secondary pressure fluid source.

Hence, the secondary supply port and the secondary supply valve can provide a second source of pressure fluid, independent from the truck park brake supply port and its pressure fluid supply.

According to another aspect, the invention refers to a vehicle combination, in particular a truck-trailer combination, with a braking system according to the present invention.

Hence, the braking system, in particular the implementation of the secondary supply valve, can be provided as an integral or an external part of the truck/tractor of such vehicle combination or as a part of the EPBC or GSAT, or the like.

In a further aspect, the present invention refers to a method for operating a braking system and/or a vehicle combination with a braking system, in particular a braking system and/or a vehicle combination according to the present invention, comprising the following steps:
checking the fluid pressure between the truck park brake supply port and the control valve;
detecting a fluid leakage, in particular a loss of fluid pressure below a predeterminable threshold value, between the truck park brake supply port and the control valve;
switching, in particular activating, the at least one secondary supply valve such that a fluid connection between the secondary supply port and the control valve is provided;
whereby pressure fluid can be provided via the secondary supply port of the braking system via the control valve to the truck park brake chamber(s).

Hence, the (backup) supply of pressure fluid via the secondary supply valve/secondary supply port can be provided on a temporarily basis and as needed, based on a determined leakage.

Preferably, the method is considered to be executed with/by a braking system using air as an operating fluid, in particular compressed air.

The control valve hereby ensures that the higher fluid pressure applied either at the truck park brake supply port or via the (activated/connected) secondary supply valve can provide/feed sufficient pressure fluid to the truck park brake chamber(s).

According to one preferred embodiment, the step of checking the fluid pressure is at least executed when pressure fluid is provided to the truck park brake supply port, preferably at least once or on a regular timely basis.

In particular, by a regular check of the fluid pressure a fluid pressure leakage between the truck park brake supply port and the control valve can be determined.

Preferably, the braking system can comprise a control unit for analyzing and/or processing measurements, e.g. by the sensor unit. Moreover, the control unit can be provided to control and/or regulate valves, like the secondary supply valve and/or the truck-trailer valve, in a suitable manner.

Moreover, a braking system and/or a vehicle combination according to the present invention is preferably considered to be configured to allow the execution of a method according to the present invention.

In a further embodiment, the truck-trailer valve is switched, subsequently or simultaneously to the switching of the at least one secondary supply valve, such that a fluid connection between the primary pressure fluid source, the truck park brake supply port and/or trailer control line port is established in order to provide a fluid pressure to the trailer control line port, in particular to release a trailer service brake.

In particular, by the at least one truck-trailer valve the truck park brake supply port can be disconnected from the primary pressure fluid source of the braking system to avoid unnecessary loss of pressure fluid via the leakage/ruptured/broken fluid connection.

Instead, only the trailer control line port can be connected with the primary pressure fluid supply in order to allow for a suitable handling of the trailer service brakes.

Thus, in particular in case of the secondary supply valve providing a fluid connection to supply pressure fluid to the truck park brake chamber(s), the trailer control line can be fed with pressure fluid to allow for an independent, at least partial, release of the trailer service brake.

According to another embodiment, the secondary supply valve is switched, preferably activated, to provide a fluid connection between the secondary supply port and the truck park brake chamber via the control valve when:
a fluid pressure between the truck park brake supply port and the control valve is lower than a predeterminable threshold value, in particular below a contact pressure threshold, or
a predeterminable threshold value of fluid pressure is not providable within a predeterminable time range.

Hence, in case of a leakage or a (sudden) burst/breakage of fluid connection between the truck park brake supply port and the control valve, a sufficient and appropriate pressure fluid supply can be ensured via switching of the secondary supply valve to provide pressure fluid from the secondary supply port via the control valve to the truck park brake chamber(s).

For example, in case of an EPBC, an EPB detection routine can check whether there is an implausible high negative gradient on the truck's park brake chamber pressure, e.g. in case of a sudden pipe breaking, or whether this pressure simply falls short a certain threshold. A precondition for such routine can be that the truck's parking brake is released.

The pre-determinable threshold can be a so-called contact pressure threshold which means that the brake pads are in contact with the brake disc/drum and that a brake force can be present/provided.

Alternatively, another EPBC detection routine can occur when the truck's park brake is in parked position (engaged). With an intact system, there is a well-defined timeout within which the parking brake chamber pressure has to reach the released pressure threshold (assuming that there is enough supply pressure to reach this pressure threshold).

In this case, the EPBC's detection routine can start a counter when a request to release the truck's park brake is received. The counter can be compared to a pre-defined threshold. This comparison either results in a failed release attempt or is terminated when the target pressure threshold is reached within the pre-definable timeout.

Hence, an advantageous control and/or regulation for checking of the regular operation of the braking system can be provided.

In another embodiment, the predeterminable threshold value of fluid pressure is about 8 bar.

In particular, if the trailer control line port is pressurized to more than eight (8) bar, there is no brake force on the trailer service break. However, if the pressure is decreased on the trailer control line (port) down to zero (0) bar, proportional to it, brake force is present on the trailer service brakes.

All of the structural and functional features as described above in the context of the braking system according to the present invention as well as its embodiments can be considered for or applied/used, alone or in combination with each other, for a method according to the present invention in order to achieve the advantages being associated therewith respectively.

Further details and advantages of the invention will be described and outlined in the following with respect to embodiments as illustrated in the enclosed figures.

### BRIEF DESCRIPTION OF THE DRAWINGS

FIG. 1 is a schematic block diagram of a first embodiment of a braking system; and

FIG. 2 is a flow chart of a method for operating a braking system according to FIG. 1.

### DETAILED DESCRIPTION OF THE DRAWINGS

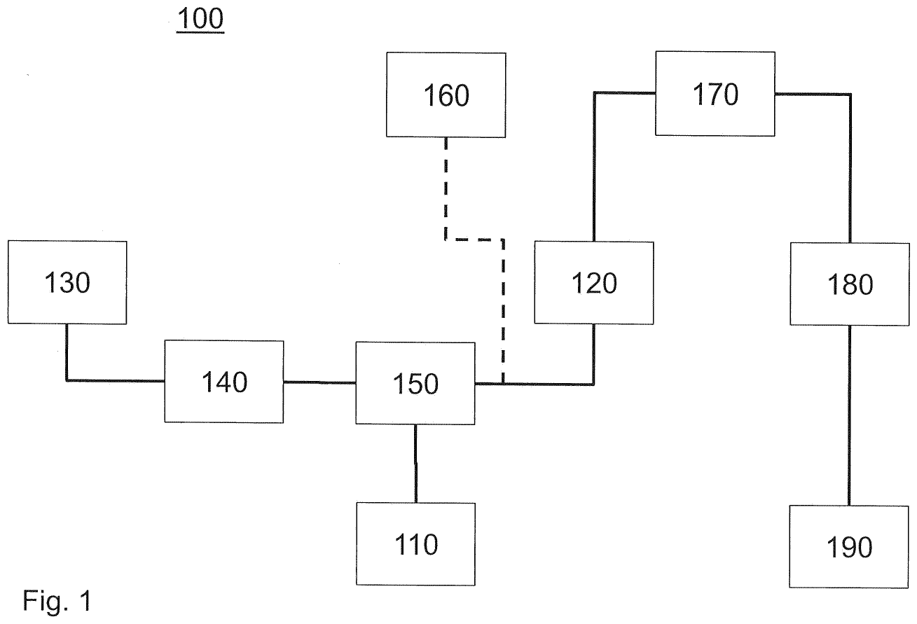

FIG. 1 shows a schematic illustration of a first embodiment of a braking system 100.

The braking system 100 can be provided with at least one truck park brake chamber 110 and a trailer service brake 190.

The truck park brake 110 comprises a fluid connection to the control valve 150.

Preferably, the control valve 150 can be a select high valve.

The control valve 150 can comprise a fluid connection to a secondary supply valve 140 and a truck park brake supply port 120.

The secondary supply valve 140 can preferably be provided in form of a solenoid valve.

Moreover, the braking system 100 comprises a sensor unit 160 that is capable of determining/measuring a fluid pressure between the truck park brake supply port 120 and the control valve 150, in particular to determine a fluid pressure leakage and/or a drop/loss of fluid pressure, e.g. by a (sudden) break/rupture of the fluid connection.

The secondary supply valve 140 comprises a fluid connection with a secondary supply port 130.

The secondary supply port 130 can preferably be connected to a secondary, in particular redundant, pressure fluid source, like e.g. a trailer pressure fluid tank or the like.

The truck park brake supply port 120 comprises a fluid connection to at least one truck-trailer valve 170.

Via the at least one truck-trailer valve 170, a fluid connection from the truck park brake supply port 120 to a trailer control line port 180 of the braking system 100 can be provided, in order to provide at least comparable fluid pressure, or interrupted.

The trailer control line port 180 can be provided with pressure fluid/be inflated in order to control the at least one trailer service brake (chamber) 190.

The truck-trailer valve 170 can provide a fluid connection of the truck park brake supply port 120 and/or the trailer control line port 180 with a primary pressure fluid source.

The braking system 100 can comprise a control unit that is capable of controlling and/or regulating the braking system.

In particular, the control unit can receive data from the sensor unit 160.

Moreover, the control unit can be provided to control and/or regulate the secondary supply valve 140, the at least one trailer-truck valve 170, and/or the control valve 150.

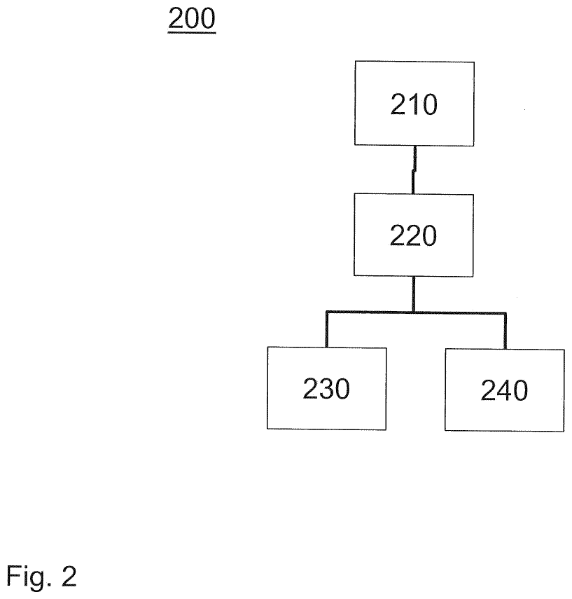

In FIG. 2, an embodiment of a method 200 for operating a braking system according to FIG. 1 is illustrated in form of a flow chart.

In one step 210, a fluid pressure can be checked/measured/determined between the truck park brake supply port 120 and the control valve 150.

In another step 220, a fluid leakage can be determined on basis of the fluid pressure, preferably as previously determined.

A fluid leakage can occur either in terms of a break/bust of a fluid connection pipe such that a pressure loss occurs.

Alternatively, a leakage may be determined 220 on basis of a timeout during the attempt to build up a certain fluid pressure in the fluid connection between the truck park brake supply port 120 and the control valve 150.

Preferably, a measurement/determination and/or detection 220 of a fluid leakage can be executed by the sensor unit 160, in particular in combination with a control unit of the braking system 100, e.g. as part of an EPBC or a GSAT.

In a further step 230, the secondary supply valve 140 can be switched in order to provide a fluid connection between the secondary supply port 130 to the control valve 150.

In case of a leakage between the truck park brake supply port 120 and the control valve 150, the higher fluid pressure being supplied via the secondary supply port 130 can be fed through to the truck park brake (chamber(s)).

Subsequently or simultaneously, the truck-trailer valve 170 can be switched 240 in order to allow a fluid pressure to be applied on the trailer control line port 180.

In particular, a fluid connection between the truck park brake supply port 120 and the trailer control line port 180 can be interrupted by switching of the at least one trailer-truck valve 170, in order to avoid a loss of fluid pressure due to the leakage between the truck park brake supply port 120 and the control valve 150.

The switching of the truck-trailer valve 240 can further provide a fluid connection between a primary pressure fluid source of the braking system 100 and the trailer control line port 180.

Preferably, a fluid pressure can be applied to the trailer control line port 180 in order to allow for the trailer service brakes 190 to be released.

By the method 200, the vehicle combination, i.e. a truck-trailer combination, having a braking system 100 can be mobilized.

In more detail, the functionality of the braking system 100 can be described as follows.

In case a truck is parked, the truck park brake supply 120 port and the trailer control line port 180 can have ambient pressure.

Thereby, the trailer is not parked, but trailer service brakes 190 are actuated, such that moving of the trailer is not possible with rolling wheels.

The driver/user can request the truck park brake 110 to be deactivated (released/disengaged), by pressurizing/providing fluid pressure at the truck park brake supply port 120 and via the control valve 150 to the truck park brake chamber(s) 110.

If a break/rupture/leakage occurs between the truck park brake supply port 120 and the control valve 150 and the break cross section/leakage is large enough, no or only a minimal pressure increase will occur at the truck park brake supply port 120.

By detection of such lack of fluid pressure 210; 220, preferably by the sensor unit 160 in combination with a control unit of the braking system 100, the supply of fluid pressure to the truck park brake 110, in order to deactivate/release the truck park brake 110, can be stopped.

In a next step, the secondary supply valve 140 can be activated/switched 230 in order to provide a fluid connection from the secondary supply port 130 via the control valve 150 to the truck park brake (chamber(s)) 110 for feeding of pressure fluid and thus pressurizing/inflating the truck park brake (chamber(s)) 110.

The control valve 150 can hereby ensure that the pressure fluid supplied via secondary supply port 130 is forwarded to the truck park brake (chamber(s)) 110.

Preferably, in parallel, or subsequently, the at least one truck-trailer valve 170 can be actuated/switched 240 in order to pressurize the trailer control line port 180, e.g. in parallel, to be able to deactivate trailer service brakes 190.

By switching 240 of the at least one truck-trailer valve 170, also a fluid connection between the primary pressure fluid source of the braking system 100 and/or the trailer control line port 180 to the truck park brake supply port 120 can be interrupted in order to (ongoing) avoid loss of pressure fluid/fluid pressure due to the leakage/pipe breakage. In consequence, the vehicle combination can be moved to another spot.

In another situation, the vehicle/truck-trailer combination can be driving (at any speed) while a (sudden) break or leakage occurs between the truck park brake supply port 120 and the control valve 150.

As a consequence, a rapid and/or relevant fluid pressure drop occur at the trailer control line port 180 and can be detected 210; 220.

By the truck park brake supply port 120 being connected to the trailer control line port 180 via the truck-trailer valve 170, truck park brakes 110 are going to be actuated as well as the trailer service brakes 190 will also apply brake force due to low pressure on the trailer control line port 180.

In a next step, the secondary supply valve can be switched/activated 230 in order to provide a redundant pressure fluid supply via the secondary supply port 130 to the truck park brake chamber(s) 110.

Subsequently or in parallel, the at least one trailer-truck valve 170 can be actuated 240 in order to pressurize/feed the trailer control line port 180 with pressure fluid, while the truck park brake supply port 120 is disconnected.

If the actuations, in particular of the truck park brake 110 and the trailer service brake 190, are completed, the primary pressure fluid supply for the truck park brake supply port 120 can be switched off as well. At least a fluid connection between the primary pressure fluid supply and the truck park brake supply port 120 can be interrupted by the truck-trailer valve 170.

The truck-trailer combination is mobilized without allowing a further loss of pressure fluid by the damaged or leaking fluid connection.

In summary, the present invention provides a braking system 100 which comprises an efficient approach for a backup fluid pressure supply without the necessity to include extensive infrastructure. Rather, a leakage or a breakage of a fluid connection, in particular between the truck park brake supply port 120 and the control valve 150, can be compensated on basis of a present secondary pressure fluid source, like a trailer tank, and via switching of the secondary supply valve 140.

In consequence, the loss of pressure fluid can be reduced while the truck-trailer/vehicle combination can be mobilized again, by inflation of the truck park brake 110 via the switched secondary supply valve 140 and the independent actuation of trailer service brakes 190 by separate/individual pressurization of the trailer control line port 180.

Reference numerals

| | |
|---|---|
| 100 | Braking system |
| 110 | Truck park brake (chamber(s)) |
| 120 | Truck park brake supply port |
| 130 | Secondary supply port |
| 140 | Secondary supply valve |
| 150 | Control valve/Select high valve |
| 160 | Sensor unit |
| 170 | Truck-trailer valve |
| 180 | Trailer control line port |
| 190 | Trailer service brake (chamber(s)) |
| 200 | Method |
| 210 | Checking of fluid pressure |
| 220 | Detecting/Determining a fluid leakage |
| 230 | Switching secondary supply valve |
| 240 | Switching truck-trailer valve |

1.-13. (canceled)

14. A braking system for an electronic park brake control system or a global scalable air treatment system of a trailer-vehicle combination, comprising:
at least one truck park brake chamber;
at least one truck park brake supply port;
at least one secondary supply port;
at least one secondary supply valve; and
at least one control valve,
wherein the control valve comprises a fluid connection to the at least one truck park brake chamber, the at least one secondary supply valve and the truck park brake supply port,
wherein the at least one secondary supply valve comprises a fluid connection to the secondary supply port and to the control valve,
wherein the at least one secondary supply valve comprises a fluid connection to the at least one truck park brake chamber via the control valve such that the at least one truck park brake chamber is providable with pressure fluid via the truck park brake supply port and/or the secondary supply port, to allow for pressure fluid to be provided from a primary pressure fluid source via the truck park brake supply port and/or from a secondary pressure fluid source via the secondary supply port to the at least one truck park brake chamber.

15. The braking system according to claim 14, wherein the at least one control valve is a select high valve.

16. The braking system according to claim 14, wherein
the truck park brake supply port and the secondary supply port are capable of providing pressure fluid to the truck park brake chamber from different, redundant, sources of pressure fluid.

17. The braking system according to claim 16, wherein the source of pressure fluid comprises the primary pressure fluid source and the secondary pressure fluid source.

18. The braking system according to claim 14, further comprising:
a trailer control line port for providing pressure fluid to a trailer service brake; and
at least one truck-trailer valve,
wherein a fluid connection between a primary pressure fluid source, the truck park brake supply port and/or the trailer control line port is providable via the at least one truck-trailer valve such that at least a comparable fluid pressure can be applied at the trailer control line port or at the truck park brake supply port or at both of them simultaneously.

19. The braking system according to claim 18, wherein the truck-trailer valve is a truck-trailer solenoid valve.

20. The braking system according to claim 14, wherein
the at least one secondary supply valve is provided as a solenoid valve,
whereby the at least one secondary supply valve in its deactivated state interrupts a fluid connection between the secondary supply port and the control valve.

21. The braking system according to claim 14, further comprising:
a sensor unit for detection of a fluid pressure in the fluid connection between the truck park brake supply port and the control valve.

22. The braking system according to claim 14, wherein,
the secondary supply valve is provided as an external valve to be controlled via an analog control connection, or provided as an integral part of an electronic park brake control system or of an global scalable air treatment system.

23. The braking system according to claim 14, wherein,
the secondary supply port is a trailer tank supply port and/or comprises a fluid connection to a trailer tank as a secondary pressure fluid source.

24. A truck-trailer combination comprising a braking system according to claim 14.

25. A method for operating a braking system having:
at least one truck park brake chamber;
at least one truck park brake supply port;
at least one secondary supply port;
at least one secondary supply valve; and
at least one control valve,
wherein the control valve comprises a fluid connection to the at least one truck park brake chamber, the at least one secondary supply valve and the truck park brake supply port,
wherein the at least one secondary supply valve comprises a fluid connection to the secondary supply port and to the control valve,
wherein the at least one secondary supply valve comprises a fluid connection to the at least one truck park brake chamber via the control valve such that the at least one truck park brake chamber is providable with pressure fluid via the truck park brake supply port and/or the secondary supply port, to allow for pressure fluid to be provided from a primary pressure fluid source via the truck park brake supply port and/or from a secondary pressure fluid source via the secondary supply port to the at least one truck park brake chamber
the method comprising the steps of:
checking the fluid pressure between the truck park brake supply port and the control valve;
detecting a loss of fluid pressure below a predeterminable threshold value, between the truck park brake supply port and the control valve;
switching the at least one secondary supply valve such that a fluid connection between the secondary supply port and the control valve is provided;
wherein pressure fluid is provided from the secondary supply port of the braking system via the control valve to the truck park brake chamber.

26. The method according to claim 25, wherein
the step of checking the fluid pressure is at least executed when pressure fluid is provided to the truck park brake supply port.

27. The method according to claim 25, wherein
the truck-trailer valve is switched, subsequently or simultaneously to the switching of the at least one secondary supply valve, such that a fluid connection between the primary pressure fluid source, the truck park brake supply port and/or trailer control line port is established in order to provide a fluid pressure to the trailer control line port to release a trailer service brake.

28. The method according to claim 25, wherein
the secondary supply valve is switched to provide a fluid connection between the secondary supply port and the truck park brake chamber via the control valve when:
a fluid pressure between the truck park brake supply port and the control valve is lower than a predeterminable threshold value, or
a predeterminable threshold value of fluid pressure is not providable within a predeterminable time range.

29. The method according to claim 25, wherein
the predeterminable threshold value of fluid pressure is about 8 bar.
